(19) United States
(12) Patent Application Publication
(10) Pub. No.: US 2001/0015334 A1
(43) Pub. Date: Aug. 23, 2001

(54) Facilitaed transport separation membranes using solid state polymer electrolytes

(75) Inventors: Young-Soo Kang, Seoul (KR); Hyun-Chae Park, Seoul (KR); Jong-Ok Won, Seoul (KR); Seoung-Uk Hong, Taejeon (KR); Tak-Min Kwon, Kyungki-do (KR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Korea Institute of Science and Technology, Seoul (KR)

(21) Appl. No.: 09/749,953

(22) Filed: Dec. 29, 2000

(30) Foreign Application Priority Data
Dec. 30, 1999 (KR) 1999-65673

(51) Int. Cl. B01D 71/02

(52) U.S. Cl. 210/490; 210/500.25; 210/500.28

(57) ABSTRACT

The present invention relates to a non-volatile facilitated transport separation membrane prepared by using a solid state polymer electrolyte, characterized in that it has good stability and improved permeance and selectivity of alkene-series unsaturated hydrocarbons.

According to the present invention, the facilitated transport separation membrane for the separation of alkene-series hydrocarbons is prepared by forming a solid state polymer electrolyte layer consisting of a non-volatile polymer and a transition metal salt capable of selectively and reversibly forming a complex with alkenes to a porous membrane. The facilitated transport separation membrane thus prepared is characterized in that its permeance and selectivity of the alkenes are high, and that the complex formed by a polymer ligand and a metal in the solid state polymer electrolyte maintains its activity as a carrier of alkene-series hydrocarbons is maintained for a long time, even under dry, long-term operation.

### BACKGROUND OF THE INVENTION

1. Field of the Invention

The present invention relates to a facilitated transport separation membrane having a high long-term operation stability and an improved permeance and selectivity of alkene-series unsaturated hydrocarbons, wherein the separation membrane is prepared by using a solid state polymer electrolyte. More specifically, the present invention relates to a facilitated transport separation membrane prepared by coating a solid state polymer electrolyte layer consisting of a transition metal salt and a non-volatile polymer onto a porous membrane having a high permeance and good mechanical strength, wherein the separation membrane is characterized in that its permeance and selectivity to alkenes is high and in that the complex formed by a polymer ligand and metal in the solid state polymer electrolyte maintains its activity as a carrier for alkene-series hydrocarbons for a long time, even under dry, long-term operation.

2. Description of the Prior Art

Alkene-series hydrocarbons, such as ethylene and propylene, are important raw materials that form the basis of the current petrochemical industry. They are primarily produced by high temperature thermal decomposition of naphtha that is obtained from a purification process of petroleum. However, since alkane-series hydrocarbons such as ethane and propane are also produced by this process of thermal decomposition, the separation technique of alkene- and alkane-series hydrocarbons is very important process in the related industry. Currently, the classical distillation process is primarily used in the separation of alkene/alkane mixtures, such as ethylene/ethane and propylene/propane. The separation of alkene/alkane mixtures, however, requires the investment of large-scale equipment and results in high energy costs due to their similarity in molecular size and physical properties, such as relative volatility.

For example, in the distillation process being used at present, a distillation column having about 120 to 160 trays should be operated at a temperature of −30° C. and at a high pressure of about 20 atm to effect separation of ethylene/ethane. To effect the separation of propylene/propane, a distillation column having about 180 to 200 trays should be operated at a temperature of −30° C. and at several atms in the reflux ratio of 10 or more. Therefore, there has been a continued need for the development of a new separation process that can replace the prior distillation process, which requires investment of large-scale equipment and high-energy costs.

A separation process that could be considered as a replacement for prior distillation processes that require large investments into equipment and high operational costs is one that uses a separation membrane. The separation membrane technique has progressed remarkably over the past few decades in the field of separating gas mixtures, for example, the separation of nitrogen/oxygen, nitrogen/carbon dioxide and nitrogen/methane, and the like.

In a mixture of alkene/alkane, however, the satisfactory separation performance can not be accomplished by using classical gas separation membranes because they are very similar in terms of their molecular size and physical properties. The facilitated transport separation membrane, which is based on a difference from the classical gas separation membrane, is one example of a separation membrane that is obtainable from a better separation performance for the alkene/alkane mixture.

In a separation process of mixtures using a separation membrane, the separation is established by a difference in permeance between the individual components constituting mixtures. Because the permeance has reverse relation with the selectivity in most separation membrane materials, the applicability of said separation membrane materials is highly limited. Nevertheless, the concurrent increase in permeance and selectivity is made possible by applying the facilitated transport phenomenon. Therefore, the scope of application can be considerably extended. Where a carrier capable of reacting reversibly with a specific component of mixtures is present in the separation membrane, the mass transport is facilitated by additional mass transport, resulting from a reversible reaction. Therefore, overall mass transport can be indicated by the sum of the mass transport according to Fick's law and by a carrier. This phenomenon is referred to as a facilitated transport.

An example of a membrane prepared by using the concept of facilitated transport is a supported liquid membrane. The supported liquid membrane is prepared by filling a porous thin membrane with solution that is obtained by dissolving a carrier capable of facilitating mass transport in a solvent, such as water. Supported liquid membranes of this type have succeeded to a certain extent.

By using a membrane of this type, for example, Steigelmann and Hughes (U.S. Pat. Nos. 3,758,603 and 3,758,605) prepared a supported liquid membrane wherein the selectivity of ethylene/ethane is about 400 to 700 and the permeance of ethylene is 60 GPU [1 GPU=1×10⁻⁶ cm³(STP)/cm² sec cmHg], which are considerably satisfactory performance results for permeation separation. However, such a supported liquid membrane exhibits the facilitated transport phenomenon only under humid conditions. For this reason, there is the inherent problem that the initial permeation separation performance cannot be maintained for an extended amount of time due to the solvent loss and the decrease of separation performance with time.

To solve this problem of the supported liquid membrane, a method which allows facilitated transport ability by substituting a suitable ion for an ion exchange resin was proposed by Kimura, et al. (see U.S. Pat. No. 4,318,714). However, this ion exchange resin membrane also has a drawback in that the facilitated transport phenomenon is exhibited only under humid conditions, which is similar to the supported liquid membrane.

Another method proposed by Ho is a process for producing a complex by using water-soluble glassy polymer, such as polyvinyl alcohol (see U.S. Pat. Nos. 5,015,268 and 5,062,866). However, this method also had a drawback in that satisfactory results can be obtained only where feed gas is saturated with water vapor by passing it through water, or where a membrane is swelled by using ethyleneglycol or water.

In all the instances described above, the separation membrane has to be maintained in humid conditions that contain water or other similar solvents. When a dry hydrocarbon gas mixture free of solvent, such as water, is separated by using said membranes, the separation performance is very low. Therefore, a method in which solvent is supplemented periodically to maintain the membrane always in humid conditions should be devised. But such a method is rarely possible when applied to a practical process, and the membrane of this type is not stable.

Kraus, et al. have developed a facilitated transport separation membrane by using another method (see U.S. Pat. No. 4,614,524). According to this patent, Ag ion is substituted in an ion exchange membrane, such as Nafion, and said membrane is then plasticized, for example, with glycerol. However, the membrane could not be utilized in that the selectivity of ethylene/ethane is as low as about 10 when a dry feed is used. And when a plasticizer is not used, the selectivity could not be seen.

Thus, the development of a separation membrane in which selectivity and permeance are high and the activity can be maintained even in a long-term operation under dry feed conditions owing to the absence of volatile components is sincerely required so as to replace the prior distillation process, requiring the high investments into equipment and energy costs.

Considering that usual polymer separation membranes cannot separate alkene/alkane mixtures having similar molecular size and physical properties as described above, use of a facilitated transport separation membrane capable of selectively separating only alkene is needed. In conventional facilitated transport separation membranes, however, the activity of a carrier should be maintained by the following method: filling a solution containing a carrier into a porous membrane, adding a volatile plasticizer, or saturating feed gases with water vapor, etc. Such a conventional facilitated transport separation membrane can not be utilized due to the problem of declining the stability of the membrane, since constitutive materials are gradually lost with time. There is also the problem of having to remove solvents later, such as water, which are added periodically to maintain the activity of the membrane, from the separated product.

### SUMMARY OF THE INVENTION

Therefore, the purpose of the present invention is to prepare a facilitated transport separation membrane by introducing the principle of non-volatile polymer electrolytes into a facilitated transport separation membrane, wherein the permeance and selectivity for unsaturated hydrocarbons, for example, alkene, are high even under dry conditions, wherein there are no stability problems such as with carrier loss, and with which it is possible to maintain the activity for a long time.

That is, an object of the present invention is to prepare a facilitated transport separation membrane for use in the separation of alkene-series hydrocarbons from alkene- and alkane-series hydrocarbon mixtures. The membrane has the superior properties of high permeance and selectivity to alkene as well as activity that can be maintained under dry, long-term operating conditions without being supplied liquid solvents.

### DETAILED DESCRIPTION OF THE INVENTION

This object of the present invention is accomplished through the use of a facilitated transport composite separation membrane for the separation of alkene-series hydrocarbons; said membrane consisting of a porous supported membrane and a polymer electrolyte layer consisting of a non-volatile polymer and a transition metal salt capable of selectively and reversibly reacting with alkenes and being a solid state at operation temperature, wherein the composite separation membrane has a selective permeance expressed by [(permeance of pure alkene)²/permeance of pure alkane] for a hydrocarbon mixture feed to be separated of at least 100 GPU (1×10⁻⁴ cm³(STP)/cm² sec cmHg).

The present invention is described in greater detail below.

The facilitated transport separation membrane according to the present invention is composed of a solid state polymer electrolyte having a selective permeance for alkene-series hydrocarbons and a porous supported membrane supporting it.

Any supported membrane having good permeance and sufficient mechanical strength can be used in the present invention. For example, both a conventional porous polymer membrane and a porous ceramic supported membrane may be used. Plate type, tubular type, hollow fiber type, capillary type or other types of supported membranes may also be used.

The solid state polymer electrolyte used in the present invention is composed of a metal salt acting as a carrier and of a non-volatile polymer. The metal salts in the electrolyte is not simply dispersed or mixed in the polymer, but is dissociated into a cation of metal and an anion of salt on the polymer. Contrary to conventional membranes, the facilitated transport separation membrane of the present invention does not require the addition of water to maintain the activity of the carrier and other materials to swell the polymer matrix, and it selectively facilitates the transport of alkene-series hydrocarbons under dry conditions.

That which affects the selective separation of alkene-series hydrocarbons in the facilitated transport separation membrane according to the present invention is the electrolyte consisting of a metal salt acting as a carrier and of a non-volatile polymer, wherein the features of selective permeation separation of alkene-series hydrocarbons from the corresponding alkenes are determined according to the properties of the electrolyte. A metal salt is composed of a cation of transition metals and an anion of salts, and, therefore they are dissociated with ions on the polymer. As a result, the cation of metals forms a complex via reversible reaction with the double bond of alkene-series hydrocarbons and directly takes part in the facilitated transport. That is, the cation of metals is interacted with the anion of salts, the polymer and the alkene-series hydrocarbons and, therefore, must be properly selected to obtain a membrane with high selectivity and permeance.

It is a well-known fact that transition metals reversibly react with alkene-series hydrocarbons in a solution [Chem. Rev. 1973]. The performance of transition metal ions as a carrier is determined by the degree of- complexation formed with alkenes, which is determined by electronegativity. The electronegativity refers to a measure of relative strength attracting covalent electrons when one atom binds to other atoms. The electronegativity values of transition metals are shown in Table 1 below.

TABLE 1
Electronegativity of Transition Metals

| Transition Metals | Sc | Ti | V | Cr | Mn | Fe | Co | Ni | Cu |
|---|---|---|---|---|---|---|---|---|---|
| Electronegativity | 1.4 | 1.5 | 1.6 | 1.7 | 1.6 | 1.8 | 1.9 | 1.9 | 1.9 |
| Transition Metals | Y | Zr | Nb | Mo | Tc | Ru | Rh | Pd | Ag |
| Electronegativity | 1.3 | 1.3 | 1.6 | 2.2 | 1.9 | 2.2 | 2.3 | 2.2 | 1.9 |
| Transition Metals | La | Hf | Ta | W | Re | Os | Ir | Pt | Au |
| Electronegativity | 1.0 | 1.3 | 1.5 | 2.4 | 1.9 | 2.2 | 2.2 | 2.3 | 2.5 |

If the electronegativity of a metal is high, a metal atom will more strongly attract electrons when it binds with other atoms. If the electronegativity of a metal is too high, the possibility of irreversible reaction with metals and- elections of alkenes become large, and, thus, the metal is not suitable as a carrier of the facilitated transport. On the other hand, however, if the electronegativity of metals is too low, it cannot serve as a carrier because of the low interaction with alkenes.

Therefore, the electronegativity of metals is suitable when in the range of about 1.6 to 2.3 in order that transition metal ions react reversibly with alkenes. Preferred transition metals within the above ranges include Mn, Fe, Co, Ni, Cu, Mo, Tc, Ru, Rh, Pd, Ag, Re, Os, Ir, Pt, or a complex thereof and so on.

Anions of transition metal salts play an important role in that they increase the reversible reactivity of transition metal ions with alkene-series hydrocarbons. In particular, they increase the reverse reaction rate of alkenes which have formed a complex with transition metal, allowing to readily separate alkenes in effluent side. In order for the transition metals to play a role as carriers of alkenes, transition metal salts MX should be solvated on the polymer and form a complex as shown scheme 1 below:

[Scheme 1]

MX+[G]→M−X−[G]

wherein, [G] and M−X−[G] represent a functional group of a polymer and a complex, respectively. The differences in solvation tendency on the polymer for anions, which can form transition metal salt, is generally dependent on the differences in dielectric constants of polymers, but the solvation stability for most anions is generally reduced in cases where the polarity of the polymer is low. The lower the lattice energy of transition metal salts, the lesser the tendency of anions and cations to form strong ion pairs. As a result, the decrease in the solvation stability of anions is relieved.

Therefore, anions of transition metal salts are preferably selected from those having low lattice energy for the given transition metal cations in order to readily solvate transition metal salts and to increase the solvation stability in the desired facilitated transport separation membrane of the present invention. Table 2 below shows the lattice energy of representative transition metal salts.

TABLE 2
Lattice Energy of Metal Salts [KJ/mol]^{a)}

| | Li⁺ | Na⁺ | K⁺ | Ag⁺ | Cu⁺ | Co²⁺ | Mo²⁺ | Pd²⁺ | Ni²⁺ | Ru³⁺ |
|---|---|---|---|---|---|---|---|---|---|---|
| F⁻ | 1036 | 923 | 823 | 967 | 1060^{b)} | 3018 | | | 3066 | |
| Cl⁻ | 853 | 786 | 715 | 915 | 996 | 2691 | 2733 | 2778 | 2772 | 5245 |
| Br⁻ | 807 | 747 | 682 | 904 | 979 | 2629 | 2742 | 2741 | 2709 | 5223 |
| I⁻ | 757 | 704 | 649 | 889 | 966 | 2545 | 2630 | 2748 | 2623 | 5222 |
| CN⁻ | 849 | 739 | 669 | 914 | 1035 | | | | | |
| NO₃⁻ | 848 | 756 | 687 | 822 | 854^{b)} | 2626 | | | 2709 | |
| BF₄⁻ | 705^{b)} | 619 | 631 | 658^{b)} | 695^{b)} | 2127 | | | 2136 | |
| ClO₄⁻ | 723 | 648 | 602 | 667^{b)} | 712^{b)} | | | | | |
| CF₃SO₂⁻ | 779^{b)} | 685^{b)} | 600^{b)} | 719^{b)} | 793^{b)} | | | | | |
| CF₃CO₂⁻ | 822^{b)} | 726^{b)} | 658^{b)} | 782^{b)} | 848^{b)} | | | | | |
| ^{a)}: See, H. D. B. Jenkins, CRC Handbook, 74^{th} Ed., 12-13 (1993) | | | | | | | | | | |
| ^{b)}: The complexation energy for the formation of ion pairs, for example M⁺_{(g)} + X⁻_{(g)} → MX_{(g)}, was calculated by using the Becke3LYP process of Density Function Theory(DFT) (Becke3/6-311 + G*//Becke3/6-311 + G*) which uses the basis set function of 6-311 + G*. It was then confirmed that there is good linearity | | | | | | | | | | |
| # with a correlation coefficient of at least 0.94 through the linear regression of the calculated value with the lattice energy described in the literature^{a)}. Therefore, the lattice energy of salts which are not disclosed in the literature was estimated by using the correlation obtained above. | | | | | | | | | | |

Anions constituting the transition metal salts of the desired facilitated transport separation membrane according to the present invention are preferably selected from anions having a lattice energy of salts of 2500 KJ/mol or less to inhibit the tendency of strong ion pairs to form with cations and to enhance solvation stability. From among the metal salts shown in Table 2 above, the anions can include F⁻, Cl⁻, Br⁻, I⁻, CN⁻, NO₃⁻ and BF₄⁻, constituting salts with Ag⁺ or Cu⁺, but anions applicable to the present invention are not limited only to those illustrated in Table 2.

The solvation stability of anions is generally exhibited in the order of F⁻<<Cl⁻< Br⁻<I⁻˜SCN⁻<ClO₄⁻˜CF₃SO₃⁻<BF₄⁻˜AsF₆⁻, wherein the lattice energy become low, i.e., the tendency of the strong ion pairs to form with cation of metal salts is reduced as it progresses toward the right. These various anions, which are suitable for the desired facilitated transport separation membrane of the present invention due to low lattice energy, are already utilized broadly in electrochemical apparatuses, such as batteries or electrochemical capacitors, etc. Such anions can include, for example, SCN⁻, ClO₄⁻, CF₃SO₃⁻, CF₃CO₂⁻, BF₄⁻, AsF₆⁻, PF₆⁻, SbF₆⁻, AlCl₄⁻, N(SO₂CF₃)₂⁻, C(SO₂CF₃)₃⁻, etc., but a large number of anions can be used in addition to those illustrated herein. Anions coinciding with the object of the present invention are not limited to those described herein.

Further, mono-salts of transition metals as well as combination salts of transition metals, such as (M₁)ₓ(M₂)ₓ,X_{y}, (M₁)ₓ(X₁)_{y}(M₂)ₓ,(X₂)_{y}, (wherein, M₁ and M₂ represent a cation and X, X₁ and X₂ represent an anion) or organic salt-transition metal salts, or a physical mixture of at least one salt may be used in the facilitated transport separation membrane of the invention.

Examples of combination salts of transition metals are RbAg₄I₅, Ag₂HgI₄, RbAg₄I₄CN, AgHgSI, AgHgTeI, Ag₃SI, Ag₆I₄WO₄, Ag₇I₄AsO₄, Ag₇I₄PO₄, Ag₁₉I₁₅P₂O₇, Rb₄Cu₁₆I₇Cl₁₃, Rb₃Cu₇Cl₁₀, AgI-(tetraalkyl ammonium iodide), AgI—(CH₃)₃SI, C₆H₁₂N₄.CH₃I—CuI, C₆H₁₂N₄.4CH₃Br—CuBr, C₆H₁₂N₄.4C₂H₅Br—CuBr, C₆H₁₂N₄.4HCl—CuCl, C₆H₁₂N₂.2CH₃I—CuI, C₆H₁₂N₂.2CH₃Br—CuBr, C₆H₁₂N₂.2CH₃Cl—CuCl, C₅H₁₁NCH₃I—CuI, C₅H₁₁NCH₃Br—CuBr, C₄H₉ON•CH₃I—CuI, etc. However, a large number of combinations similar to the combination salts or mixtures of salts indicated herein can be made within the spirit of the present invention, and, thus, the invention is not limited to the combinations indicated above.

The polymer used in the invention must easily form a complex with the transition metal salts as mentioned above to allow the reversible interaction of transition metal ions and alkenes. The tendency of polar transition metal salts to solvate on the polymer depends on the polarity between them. If the polarity of the polymer is low, the solvation stability of the transition metal salts is reduced. Thus, a high polarity of the polymer is required to increase the interaction with and enhance the solvation stability of the transition metal salts. The polarity magnitude of the polymer can be expressed by dielectric constants, and the dielectric constant of polymers (at room temperature), can be obtained by equation 1 shown below:

[Equation 1]

≅/7.0;=(E_{coh}/V)^{0.5}

wherein, is a solubility parameter, E_{coh} is a cohesive energy, and V is a molar volume, wherein said cohesive energy and said molar volume can be obtained by using the Group Contribution process proposed by Fedors (See, D. W. van Krevelen, in “Properties of Polymers,” p196). The dielectric constants of representative polymers are showed in Table 3 below.

TABLE 3
The dielectric constants of Representative Polymers

| | Solubility | Dielectric | | Solubility | Dielectric |
|---|---|---|---|---|---|
| Class | Parameter | Const. | Class | Parameter | Const. |
| Polypropylene | 16.41 | 2.34 | Poly(vinyl acetate) | 21.60 | 3.09 |
| Poly(tetrafluoro ethylene) | 20.32 | 2.9 | Poly(epichlorohydrin) | 21.87 | 3.12 |
| Polycarbonate | 22.30 | 3.29 | Poly(acryl amide) | 39.25 | 5.61 |
| Poly(N-isopropyl | 24.57 | 3.51 | Poly(oxy-2,6-dimethyl- | 22.91 | 3.27 |
| acryl amide) | | | 1,4-phenylene) | | |
| Poly(phenylene sulfide) | 26.75 | 3.82 | Poly(2-ethyl-2- | 25.73 | 3.68 |
| | | | oxazoline) | | |
| Poly(methyl methacrylate) | 20.32 | 2.90 | Poly(vinyl pyrrolidone) | 27.38 | 3.91 |
| Poly(methylene oxide) | 20.41 | 2.92 | Poly(acrylonitrile) | 29.45 | 4.21 |
| Poly(methacrylate) | 21.60 | 3.09 | Poly(methacryl amide) | 33.26 | 4.75 |
| Poly(ethylene imine) | 22.30 | 3.19 | Poly(vinyl alcohol) | 39.00 | 5.57 |
| Poly(N-dimethyl | 23.62 | 3.37 | Poly(N-dimethyl | 25.21 | 3.60 |
| methacryl amide | | | acryl amide) | | |

It is preferred that a polymer having a large dielectric constant can be used as the polymer used in solid state electrolytes of the facilitated transport separation membrane desired in the invention so as to easily form a complex with transition metal salts. Polymers with dielectric constant of at least 2.7 are suitable. The polymers within this range of the representative polymers indicated in Table 3 are poly(tetrafluoro ethylene) (PTEE), polycarbonate, poly(N-isopropyl acryl amide) (NIPAM), poly(phenylene sulfide), poly(methyl methacrylate), poly(methylene oxide), poly(styrene), poly(methacrylate), poly(vinyl acetate), poly(epichlorohydrin), poly(acryl amide), poly(oxy-2,6-dimethyl-1,4-phenylene), poly(2-ethyl-2-oxazoline), poly(vinyl pyrrolidone), poly(acrylonitrile), poly(methacryl amide), poly(vinyl alcohol), poly(ethylene imine), poly(N-dimethyl acryl amide), poly(N-dimethyl methacryl amide), etc. Any polymer that does not depart from the object of the invention and is selected from these polymers, homopolymers or copolymers thereof, or derivatives having them as a backbone or branch, or a physical mixture thereof, etc., can be used in the facilitated transport separation membrane of the present invention. In addition to the polymers shown in Table 3, various polymers coinciding with the object of the invention can be used and should not be limited to those illustrated herein.

The following describes the process for the preparation of the facilitated transport separation membrane of the invention.

The facilitated transport separation membrane of the present invention is prepared first by dissolving a transition metal salt and a polymer constituting a solid state electrolyte in a liquid solvent to form a coating solution, applying the solution on a porous supported membrane and then drying it. The liquid solvent used in the process can be any that can dissolve the transition metal and polymer without impairing the supported membrane. If the polymer constituting the solid electrolyte is water-soluble, water is used as a solvent.

The concentrations of the transition metal salt and polymer in the coating solution are determined by considering the thickness of the solid state electrolyte solution formed directly after applying and the thickness after drying. For example, if the application thickness before the drying of the coating solution is to be 100 and the final thickness of the dried solid state electrolyte layer is to be 5, the concentration of the transition metal salt and polymer in the coating solution should be 5% by weight. The weight proportion of the polymer constituting the polymer electrolyte layer used in the invention is preferably in the range of 0 to 50% by weight.

The manner in which an electrolyte coating solution is applied to a supported membrane can vary, as is already well-known. For example, blade/knife coating, Mayer bar coating, dip coating and air knife coating, and the like can be used conveniently. The thickness of the solid state electrolyte formed on the supported membrane after drying is preferably as thin as possible to enhance permeance. However, if the dry thickness of the solid state electrolyte layer is too thin, the problem of selectivity deterioration can occur, resulting from the insufficient closing of the porous supported membrane pores or the occurrence of holes in the membrane due to the pressure discrepancy when operating. Preferably, a suitable dry thickness of the solid state electrolyte layer would be no less than 0.05 and no more than 10, more preferably no less than 0.1 and no more than 3.

Another feature of the facilitated transport separation membrane thus prepared is a high selective permeance for alkenes. Herein, the selective permeance, Ps, is defined in equation 2 below:

[Equation 2]

Ps=[permeance of alkene/permeance of alkane] X permeance of alkene

wherein, [penneance of alkene/penneance of alkane] is a value representing the extent of which alkenes can be selectively separated relative to alkanes. The permeance is measured by using a pure gas. The selective permeance, Ps, increases proportionally to the increase in the selectivity of alkenes over alkanes or the permeance of alkenes. Therefore, as the selective permeance, Ps, is large, the performance of separation is better, and it is advantageously used in practical applications.

The facilitated transport separation membrane prepared in the invention is characterized in that the selective permeance, Ps, is high, being at least 100 GPU (1×10⁻⁴ cm³(STP)/cm² sec cmHg).

The feed of hydrocarbons mixture separable by the use of the facilitated transport separation membrane according to the present invention may contain at least one alkene-series hydrocarbon and at least one alkane-series hydrocarbon, or its mixture with a component, such as methane, hydrogen, acetylene, carbon monooxide or carbon dioxide. Alkene-series hydrocarbons include ethylene, propylene, butylene or iso-butylene, etc. and alkane-series hydrocarbons include ethane, propane, or butane, etc.

The facilitated transport separation membrane according to the present invention includes the solid state electrolyte being a solid state at operation temperature. In the specification, the operation temperature means the temperature at which the separation membrane is applied and actually operated. As the operation temperature is increased, the polymer constituting the solid state electrolyte is converted to a state in which ions move readily, and the activity of ions in the solid state electrolyte increases. Accordingly, the actual operation is preferably carried out at a temperature that is somewhat higher than room temperature, in the use of the facilitated transport separation membrane according to the present invention.

Therefore, the facilitated transport separation membrane according to the present invention is preferably used at an operation temperature of 300 or less, which is lower than the dissociation temperature of the transition metal salt and is in the range at which the electrolyte is solid state.

In addition to high selective permeance for alkene-series hydrocarbons, the facilitated transport separation membrane prepared according to the present invention maintains its activity even under completely dry conditions because the solid state electrolyte is composed of a metal salt and a non-volatile polymer. Further, it is preferable to apply the facilitated transport separation membrane in the practical separation process of alkane/alkene due to a high long-term operation stability resulting from the absence of a volatile component in operation.

The examples below illustrate the present invention in detail, but the invention is not limited to the scope thereof.

### EXAMPLE 1

1 g of poly(2-ethyl-2-oxazoline) [PEOx, Mw 500,000, T_{g=}60, Aldrich Co., Milwaukee, Wis.] and 2 g of silver tetrafluoroborate (AgBF₄) were mixed with 97 g of water and were then sufficiently stirred to prepare the coating solution [PEOx concentration=1 wt %, weight ratio of AgBF₄/PEOx=2/1]. The resulting solution was coated on the polysulfone porous asymmetric supported membrane of a plate type [supplied by SAE HAN Co., LTD.] by using a Mayer bar. The coated membrane was placed in a vacuum oven and left at 40 for 48 hours to be completely dried. The facilitated transport separation membrane thus prepared contained 67 wt % of Ag salt and included a coating layer of electrolyte having a dry thickness of about 1.

The membrane was cut to the size of 2×2 cm² and the gas permeance of the pure propylene and propane was assessed. The measurement of permeance was carried out at room temperature under conditions in which the pressure of feed was 60 psig and the pressure of permeation was 0 psig. The volume flow rate was determined by using a soap-bubble flow meter. Table 4 below shows the selective permeance of propylene over propane in the facilitated transport separation membrane.

[Table 4]

| | | |
|---|---|---|
| Permeance of propylene | 14.2 | GPU |
| Permeance of propane | ˜0.1 | GPU |
| Selective permeance, Ps | 2016.4 | GPU |

### EXAMPLE 2

The facilitated transport separation membrane comprising PEOx and silver hexafluorophosphate (AgPF₆) was prepared by using the method described in example 1. In the electrolyte solution coated on the separation membrane, the concentration of PEOx was 1 wt % and the weight ratio of AgPF₆ to PEOx was 2:1. The permeance of propylene and propane for the separation membrane was determined by using the method indicated in example 1. Table 5 below shows the selective permeance of propylene over propane.

TABLE 5

| | | |
|---|---|---|
| Permeance of propylene | 11.2 | GPU |
| Permeance of propane | ˜0.1 | GPU |
| Selective permeance, Ps | 1254.4 | GPU |

### EXAMPLE 3

The composite membrane of PEOx and silver trifluoromethane sulfonate (AgCF₃SO₃) was prepared by using the method described in example 1. The concentraion of PEOx in the coating solution was 1 wt % and the weight ratio of AgCF₃SO₃ to PEOx was 2:1. The permeance of propylene and propane for the separation membrane was determined by using the method as indicated in example 1. Table 6 below shows the selective permeance of propylene over propane.

TABLE 6

| | | |
|---|---|---|
| Permeance of propylene | 37.7 | GPU |
| Permeance of propane | ˜0.1 | GPU |
| Selective permeance, Ps | 14212.9 | GPU |

### EXAMPLE 4

The composite membrane of PEOx and AgBF₄ was prepared by using the method described in example 1, except where the weight ratio of AgBF₄ to PEOx was 4:1, which was the higher than example 1. The permeance of propylene and propane for the separation membrane was determined by using the method indicated in example 1. Table 7 below shows the selective permeance of propylene over propane.

TABLE 7

| | | |
|---|---|---|
| Permeance of propylene | 99.1 | GPU |
| Permeance of propane | ˜0.1 | GPU |
| Selective permeance, Ps | 98208.2 | GPU |

It can be seen that the permeance of propylene in the membrane of this example was increased in comparison to example 1 and that the facilitated transport separation membrane prepared according to the present invention is stable although it contains a large amount of salt.

### EXAMPLES 5-7

In examples 5-7, the penneance of propylene and propane was measured for the separation membrane of PEOx and AgBF₄ prepared in example 1 as the temperature was elevated to 40, 50, 60. Table 8 below shows the selective permeance of propylene over propane in relation to changes in the operation temperature.

TABLE 8

| | Operation | Permeance | | Selective |
|---|---|---|---|---|
| | Temp. | of propylene | Permeance of | permeance, |
| Example | [ ] | [GPU] | propane [GPU] | Ps [GPU] |
| 1 | 25 | 14.2 | ˜0.1 | 2016.4 |
| 5 | 40 | 15.1 | ˜0.1 | 2280.1 |
| 6 | 50 | 17.3 | ˜0.1 | 2992.9 |
| 7 | 60 | 18.8 | ˜0.1 | 3534.4 |

As recognized from Table 8 above, the permeance of propylene increases relative to the rise in operation temperature. This occurs because the polymer constituting the solid state electrolyte is converted into a state in which ions move readily, and the activity of ions in the solid state electrolyte increases, as the operation temperature rises. The examples show that the practical operation is preferably carried out at a somewhat higher temperature than room temperature in the separation of alkene/alkane, such as propylene/propane, by using the facilitated transport separation membrane prepared according to the present invention.

### EXAMPLE 8

The composite membrane containing AgBF₄ salt was prepared in same method as example 4, except where poly(vinyl pyrrolidone) (PVP) (Mw=1,000,000, T_{g}≈177, Polyscience) instead of PEOx was used as a polymer. The concentration of the PVP aqeous solution used was 1 wt %, and the weight ratio of AgBF₄ to PVP was 4:1. The permeance of pure propylene and propane was determined by using the method indicated in example 1, except where the pressure of feed was 20 psig. Table 9 below shows the permeance and the selective permeance of propylene over propane.

TABLE 9

| | | |
|---|---|---|
| Permeance of propylene | 218 | GPU |
| Permeance of propane | ˜0.1 | GPU |
| Selective permeance, Ps | 4752 | |

### EXAMPLE 9

The composite membrane of PVP and AgCF₃SO₃ was prepared by using the method described in example 8. The concentration of the aqueous solution used was 1 wt %, and the weight ratio of AgCF₃SO₃ to PVP was 4:1. The permeance of propylene and propane was determined by using the method indicated in example 1. Table 10 below shows the permeance and the selective permeance of propylene over propane.

TABLE 10

| | | |
|---|---|---|
| Permeance of propylene | 183 | GPU |
| Permeance of propane | ˜0.1 | GPU |
| Selective permeance, Ps | 334890 | |

### EFFECTS OF THE INVENTION

The facilitated transport separation membrane, prepared by coating a polymer electrolyte consisting of a suitable transition metal salt and a non-volatile polymer onto a porous supported membrane in accordance with the present invention, can selectively separate the alkene-series hydrocarbons by facilitating the transport of alkenes, which is results from a polymer ligand and a metal ion of a metal salt in a non-volatile polymer electrolyte forming a complex and from the double bond of the alkenes selectively and reversibly reacting with the metal ion of a complex. In addition, the facilitated transport separation membrane of the invention is suitable for the practical separation process of alkane/alkene because the activity of the electrolyte is maintained as a solid consisting of a metal salt and a non-volatile polymer, even under completely dry conditions, and the long-term operation stability is high due to the absence of volatile components upon operation.

What is claimed is:

1. A facilitated transport composite separation membrane for the separation of alkene-series hydrocarbons, consisting of a porous supported membrane and a polymer electrolyte layer consisting of a non-volatile polymer and a transition metal salt capable of selectively and reversibly reacting with alkenes and being a solid state at operation temperature, wherein the composite separation membrane has a selective permeance expressed by [(permeance of pure alkene)²/penneance of pure alkane] for a hydrocarbon mixture feed to be separated of at least 100 GPU (1×10⁻⁴ cm³(STP)/cm² sec cmHg).

2. The facilitated transport separation membrane according to claim 1, wherein a cation of the transition metal salt constituting the solid state polymer electrolyte layer has the electronegativity of 1.6 to 2.3.

3. The facilitated transport separation membrane according to claim 2, wherein the transition metal includes Mn, Fe, Co, Ni, Cu, Mo, Tc, Ru, Rh, Pd, Ag, Re, Os, Ir, Pt, or a complex thereof.

4. The facilitated transport separation membrane according to claim 1, wherein the solid state polymer electrolyte layer comprises an anion of the transition metal salt and the transition metal salt containing the anion has the lattice energy of 2500 KJ/mol or less.

5. The facilitated transport separation membrane according to claim 4, wherein the anion of the metal salt includes F⁻, Cl⁻, Br⁻, I⁻, CN⁻, NO₃⁻, SCN⁻, ClO₄⁻, CF₃SO₃⁻, CF₃CO₂⁻, BF₄⁻, ASF₆⁻, PF₆⁻, SbF₆⁻, AlCl₄⁻, N(SO₂CF₃)₂⁻ or C(SO₂CF₃)₃⁻.

6. The facilitated transport separation membrane according to claim 1, wherein the transition metal salt includes a combination salt of a transition metal or a mixture of transition metal salts.

7. The facilitated transport separation membrane according to claim 6, wherein the combination salt of the transition metal includes RbAg₄I₅, Ag₂HgI₄, RbAg₄I₄CN, AgHgSI, AgHgTeI, Ag₃SI, Ag₆I₄WO₄, Ag₇I₄AsO₄, Ag₇I₄PO₄, Ag₁₉I₁₅P₂O₇, Rb₄Cu₁₆I₇Cl₁₃, Rb₃Cu₇Cl₁₀, AgI-(tetraalkyl ammonium iodide), AgI—(CH₃)₃SI, C₆H₁₂N₄.CH₃I—CuI, C₆H₁₂N₄.4CH₃Br—CuBr, C₆H₁₂N₄.4C₂H₅Br—CuBr, C₆H₁₂N₄.4HCl—CuCl, C₆H₁₂N₂.2CH₃I—CuI, C₆H₁₂N₂.2CH₃Br—CuBr, C₆H₁₂N₂.2CH₃Cl—CuCl, C₅H₁₁NCH₃I—CuI, C₅H₁₁NCH₃Br—CuBr or C₄H₉ON•CH₃I—CuI.

8. The facilitated transport separation membrane according to claim 1, wherein the operation temperature is 300 or less which is lower than the dissociation temperature of the transition metal salt and is in the range at which the electrolyte is solid state.

9. The facilitated transport separation membrane according to claim 1, wherein the polymer has the dielectric constant of 2.7 or more.

10. The facilitated transport separation membrane according to claim 1, wherein the non-volatile polymer is selected from a group consisting of poly(tetrafluoro ethylene), polycarbonate, poly(N-isopropyl acryl amide), poly(phenylene sulfide), poly(methyl methacrylate), poly(methylene oxide), poly(methacrylate), poly(vinyl acetate), poly(epichlorohydrin), poly(acryl amide), poly(oxy-2,6-dimethyl-1,4-phenylene), poly(2-ethyl-2-oxazoline), poly(vinyl pyrrolidone), poly(acrylonitrile), poly(methacryl amide), poly(vinyl alcohol), poly(N-dimethyl acryl amide), poly(N-dimethyl methacryl amide), or homopolymers or copolymers thereof, or derivatives having them as a backbone or branch, or a physical mixture thereof.

11. The facilitated transport separation membrane according to claim 1, wherein the weight proportion of polymer constituting the polymer electrolyte layer is in the range of 0 to 50% by weight.

12. The facilitated transport separation membrane according to claim 1, wherein the porous supported membrane is a porous polymer or porous ceramic supported membrane that is used in a preparation of a conventional composite separation membrane.

13. The facilitated transport separation membrane according to claim 1, wherein the hydrocarbon mixture feed to be separated contains at least one alkene-series hydrocarbons and at least one alkane-series hydrocarbon.

14. The facilitated transport separation membrane according to claim 13, wherein the hydrocarbon mixture feed further contains a component, such as methane, hydrogen, acetylene, carbon monooxide or carbon dioxide, in addition to alkanes and alkenes.

15. The facilitated transport separation membrane according to claim 13, wherein the alkene-series hydrocarbon includes ethylene, propylene, 1-butylene, 2-butylene, iso-butylene, or 1,3-butadiene.

16. The facilitated transport separation membrane according to claim 13, wherein the alkane-series hydrocarbon includes ethane, propane, n-butane or iso-butane.
